(19) United States
(12) Patent Application Publication
(10) Pub. No.: US 2006/0213009 A1
(43) Pub. Date: Sep. 28, 2006

(54) Comfort glide hospital gurney

(76) Inventor: G. Robert Stevens, Denver, CO (US)

Correspondence Address: G. Robert Stevens, 2424 W. 44th Ave., Denver, CO, 80211, US

(21) Appl. No.: 11/089,493

(22) Filed: Mar. 25, 2005

(51) Int. Cl. A61G 7/00; A61G 7/05; A61G 13/00

(52) U.S. Cl. 5/620; 5/600

(57) ABSTRACT

This invention is intended to provide shock absorption relief for a standard hospital gurney/stretcher through the use of a spring, gas or air shock absorber mounted within each of the structural support legs of the gurney, and to accomplish a less bumpy ride throughout the patient's hospital experience.

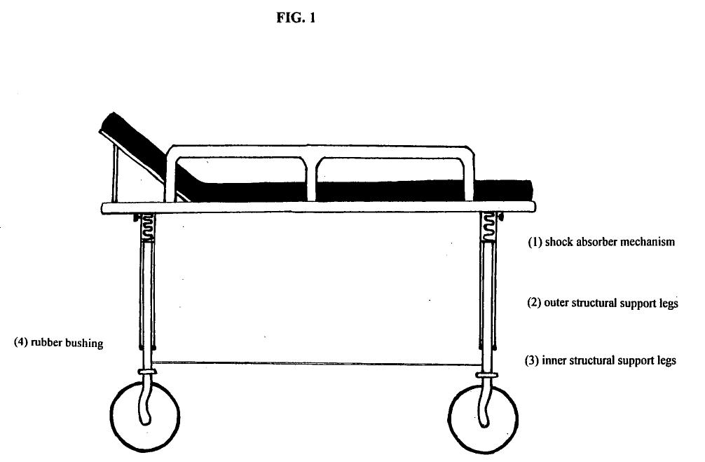

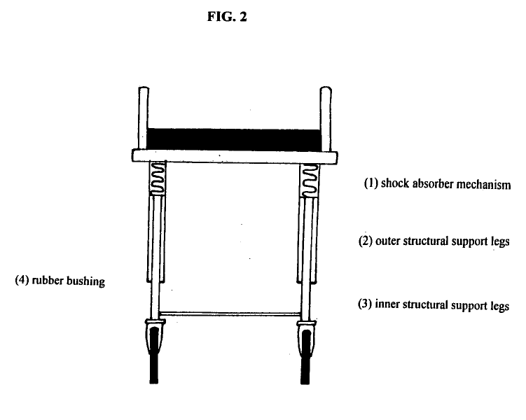

### CROSS-REFERENCE TO RELATED APPLICATIONS

Not Applicable

### FEDERALLY SPONSORED RESEARCH OR DEVOLPEMENT

Not Applicable

### REFERENCE TO SEQUENCE LISTING

Not Applicable

### BACKGROUND OF INVENTION

The Comfort Glide Hospital Gurney is a modification of an existing standard hospital gurney. The Comfort Glide Hospital Gurney is modified through the use of springs, or air, or gas shock absorbers placed within the structural support legs of the gurney.

### BRIEF SUMMARY OF THE INVENTION

Standard hospital gurneys provide no type whatsoever of shock relief for Orthopedic patients, or those with neck, spinal cord, or hip injuries. And due to this lack of shock relief, a trip through the hospital on a standard hospital gurney for such patients, or those just out of surgery, can be a painful experience. This spring, air, or gas shock absorbing system will provide relief for many those medical patients who are transported within or outside the hospital environment.

### BRIEF DESCRIPTION OF THE DRAWING

Provided is a side view of the Comfort Glide Hospital Gurney. The side view depicts a typical hospital gurney with springs placed within the structural support legs of the product. Although the air and gas shocks are not shown in the drawing, those items in fact would be placed in the same position of the support legs where the springs are shown.

### DESCRIPTION OF THE INVENTION

The Comfort Glide Hospital Gurney is a modification of an existing product. I took a standard hospital gurney and modified its structural support legs. I added springs, air or a gas type shock absorbing system to the inner upper tubing of the structural support legs; providing a comfortable cushioned ride for hospital patients who are transported upon it.

The outer structural support legs from underneath the frame of a standard hospital gurney are now enlarged in diameter to accommodate an inner support leg system to slide within it. Springs, air or gas type shock absorbers are attached to the inner support legs, which are fitted up inside the outer support legs, enabling a more comfortable transport system for hospital patients.

Adjustment to the level of shock absorbsion would be maintained through a dampening system that will either pre-compress the springs, or allow them to maintain their full shock absorbing capacity. This will be very beneficial to those patients who vary greatly in body wieght.

1. What I claim as my invention is that I added a spring, air or gas type shock absorbing system to the structural support legs of a standard hospital gurney. This addition of springs, air or gas shocks, along with enlarging the structural support legs to facilitate this shock absorbing system is my modification of an existing product, and is now my new invention.
I claim small entity status due to the fact that I am the sole inventor acting on my own behalf.
I further claim that a disclosure document was filed on Dec. 3, 2004 for this invention, but the title of invention at that time was: Spring Cushioned Hospital Gurney.
